(19) United States
(12) Patent Application Publication
(10) Pub. No.: US 2022/0036272 A1
(43) Pub. Date: Feb. 3, 2022

(54) MIGRATION EVALUATION SYSTEM AND METHOD

(71) Applicant: MYTHICS, INC., Virginia Beach, VA (US)

(72) Inventors: Mehrdad Stanley Karimi, Broomfield, CO (US); David James Bauch, Elizabeth, CO (US); Paul E. Hughes, Ashburn, VA (US); Douglas S. Altamura, Virginia Beach, VA (US); Praveen Mogili, Ashburn, VA (US); Robert Jones, Cleveland, TN (US); David Randall Hardee, Arlington, TX (US)

(21) Appl. No.: 17/387,210

(22) Filed: Jul. 28, 2021

Related U.S. Application Data
(60) Provisional application No. 63/058,409, filed on Jul. 29, 2020.
(60) Provisional application No. 63/209,777, filed on Jun. 11, 2021.

(51) Int. Cl. G06Q 10/06; G06F 9/50; G06F 8/10

(52) U.S. Cl. CPC G06Q 10/06375; G06F 8/10; G06F 9/5077; G06Q 10/06315

(57) ABSTRACT

CONCEPT 1: A system that allows a user to define their needs/requirements concerning a migration event from a course workload to a target workload (without requiring the user to define technical details concerning e.g., target hardware/target infrastructure) and provides an assessment to the user for a tailored solution that achieves such needs/requirements.

A method, computer program product, and computing system for identifying a specific migration scenario for a potential migration event from a source workload to a target workload; gathering migration information from a user concerning the potential migration event, wherein the migration information defines, in whole or in part, one or more performance requirements concerning the potential migration event; and processing the specific migration scenario and the migration information to generate a migration assessment concerning the potential migration event.

### RELATED APPLICATION(S)

This application claims the benefit of U.S. Provisional Application No. 63/058,409, filed on 29 Jul. 2020 and U.S. Provisional Application No. 63/209,777, filed on 11 Jun. 2021, their entire contents of which are incorporated herein by reference.

### TECHNICAL FIELD

This disclosure relates to migration systems and methods and, more particularly, to migration systems and methods that migrate between IT workloads.

### BACKGROUND

Various enterprises may have critical applications (e.g., accounting, enterprise resource planning, and human resources) that run on computer system hardware located on premises or within a co-location datacenter facility (referred to as “on-premise”). Increasingly, these enterprises may wish to move these systems to a public or private cloud or refreshed infrastructure in order to maximize scalability, functionality and reliability of the underlying infrastructure; while reducing the management and maintenance responsibility. In some cases, the hardware or software system vendors may be forcing this move as they discontinue support for the on-premise installations. Generally, the move of on-premise systems to a modernized environment may be referred to as a digital transformation initiative within an enterprise.

In order to accomplish such a digital transformation, infrastructure resources may be deployed in the target environment to support the systems. These infrastructure resources may consist of various virtual machines, virtual networking equipment and object level storage. Such virtual machines and other virtual resources may be of various configurations in terms of storage, memory and processing power.

A prerequisite to a digital transformation may be deciding how many and which virtual equipment should be deployed and to where. These choices are specific to each digital transformation and are the scoping component of the digital transformation lifecycle. There can be many factors to consider, including the application being migrated, which application modules (also referred to as “app pillars”) are being migrated and various characteristics of the app pillars. These characteristics include, but are not limited to, number of users, intensive CPU operations and frequency of batch processing operations.

### SUMMARY OF DISCLOSURE

CONCEPT 1: A system that allows a user to define their needs/requirements concerning a migration event from a course workload to a target workload (without requiring the user to define technical details concerning e.g., target hardware/target infrastructure) and provides an assessment to the user for a tailored solution that achieves such needs/requirements.

In one implementation, a computer-implemented method is executed on a computing device and includes: identifying a specific migration scenario for a potential migration event from a source workload to a target workload; gathering migration information from a user concerning the potential migration event, wherein the migration information defines, in whole or in part, one or more performance requirements concerning the potential migration event; and processing the specific migration scenario and the migration information to generate a migration assessment concerning the potential migration event.

One or more of the following features may be included. One or more of the source workload and the target workload may be an on-premise workload. One or more of the source workload and the target workload is an in-cloud workload. The potential migration event may concern one or more of: an application migration event; a database migration event; and an infrastructure migration event. The migration information may include one or more of: source workload information; target workload information; application information; database information; infrastructure information; redundancy information; high-availability information; performance information; data migration information; migration event timeline information; environment information; and post-migration maintenance information. The migration assessment concerning the potential migration event may be provided to the user. The migration assessment may include one or more of: a platform migration assessment; a data migration assessment; and a post-migration maintenance assessment. The specific migration scenario and/or the migration assessment may be based, at least in part, upon knowledge/best practices defined within a rules engine. The specific migration scenario may be one of a plurality of migration scenarios defined within a migration platform. The plurality of migration scenarios may be presented to the user for review. The user may be enabled to select the specific migration scenario from the plurality of migration scenarios.

In another implementation, a computer program product resides on a computer readable medium and has a plurality of instructions stored on it. When executed by a processor, the instructions cause the processor to perform operations including identifying a specific migration scenario for a potential migration event from a source workload to a target workload; gathering migration information from a user concerning the potential migration event, wherein the migration information defines, in whole or in part, one or more performance requirements concerning the potential migration event; and processing the specific migration scenario and the migration information to generate a migration assessment concerning the potential migration event.

One or more of the following features may be included. One or more of the source workload and the target workload may be an on-premise workload. One or more of the source workload and the target workload is an in-cloud workload. The potential migration event may concern one or more of: an application migration event; a database migration event; and an infrastructure migration event. The migration information may include one or more of: source workload information; target workload information; application information; database information; infrastructure information; redundancy information; high-availability information; performance information; data migration information; migration event timeline information; environment information; and post-migration maintenance information. The migration assessment concerning the potential migration event may be provided to the user. The migration assessment may include one or more of: a platform migration assessment; a data migration assessment; and a post-migration maintenance assessment. The specific migration scenario and/or the migration assessment may be based, at least in part, upon knowledge/best practices defined within a rules engine. The specific migration scenario may be one of a plurality of migration scenarios defined within a migration platform. The plurality of migration scenarios may be presented to the user for review. The user may be enabled to select the specific migration scenario from the plurality of migration scenarios.

In another implementation, a computing system includes a processor and a memory system configured to perform operations including identifying a specific migration scenario for a potential migration event from a source workload to a target workload; gathering migration information from a user concerning the potential migration event, wherein the migration information defines, in whole or in part, one or more performance requirements concerning the potential migration event; and processing the specific migration scenario and the migration information to generate a migration assessment concerning the potential migration event.

One or more of the following features may be included. One or more of the source workload and the target workload may be an on-premise workload. One or more of the source workload and the target workload is an in-cloud workload. The potential migration event may concern one or more of: an application migration event; a database migration event; and an infrastructure migration event. The migration information may include one or more of: source workload information; target workload information; application information; database information; infrastructure information; redundancy information; high-availability information; performance information; data migration information; migration event timeline information; environment information; and post-migration maintenance information. The migration assessment concerning the potential migration event may be provided to the user. The migration assessment may include one or more of: a platform migration assessment; a data migration assessment; and a post-migration maintenance assessment. The specific migration scenario and/or the migration assessment may be based, at least in part, upon knowledge/best practices defined within a rules engine. The specific migration scenario may be one of a plurality of migration scenarios defined within a migration platform. The plurality of migration scenarios may be presented to the user for review. The user may be enabled to select the specific migration scenario from the plurality of migration scenarios.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a migration evaluation process according to an embodiment of the present disclosure;

FIG. 2 is a diagrammatic view of a project to be evaluated by the migration evaluation process of FIG. 1 according to an embodiment of the present disclosure;

FIG. 3 is a flowchart of the migration evaluation process of FIG. 1 according to an embodiment of the present disclosure; and

FIGS. 4-22 are diagrammatic views of a user interface rendered by the migration evaluation process of FIG. 1 according to an embodiment of the present disclosure.

Like reference symbols in the various drawings indicate like elements.

### DETAILED DESCRIPTION OF THE PREFERRED EMBODIMENTS

System Overview

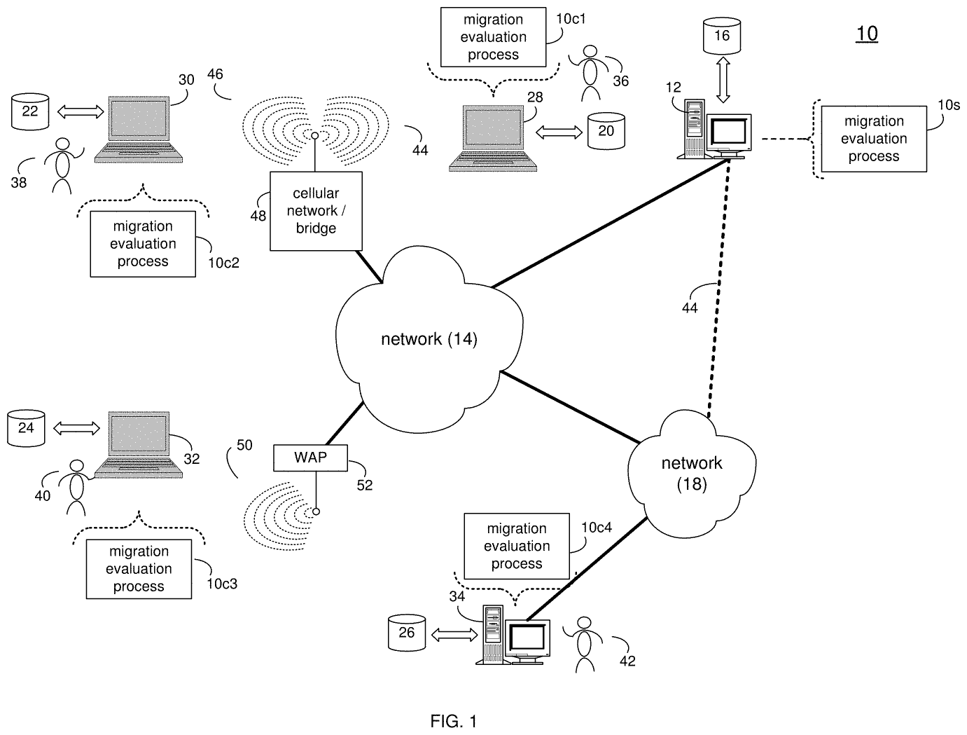

Referring to FIG. 1, there is shown migration evaluation process 10. Migration evaluation process 10 may be implemented as a server-side process, a client-side process, or a hybrid server-side/client-side process. For example, migration evaluation process 10 may be implemented as a purely server-side process via migration evaluation process 10s. Alternatively, migration evaluation process 10 may be implemented as a purely client-side process via one or more of migration evaluation process 10c1, migration evaluation process 10c2, migration evaluation process 10c3, and migration evaluation process 10c4. Alternatively still, migration evaluation process 10 may be implemented as a hybrid server-side/client-side process via migration evaluation process 10s in combination with one or more of migration evaluation process 10c1, migration evaluation process 10c2, migration evaluation process 10c3, and migration evaluation process 10c4. Accordingly, migration evaluation process 10 as used in this disclosure may include any combination of migration evaluation process 10s, migration evaluation process 10c1, migration evaluation process 10c2, migration evaluation process 10c3, and migration evaluation process 10c4.

Migration evaluation process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing platform.

The instruction sets and subroutines of migration evaluation process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of migration evaluation processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of migration evaluation processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access migration evaluation process 10 directly through network 14 or through secondary network 18. Further, migration evaluation process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Migration Evaluation Process Overview

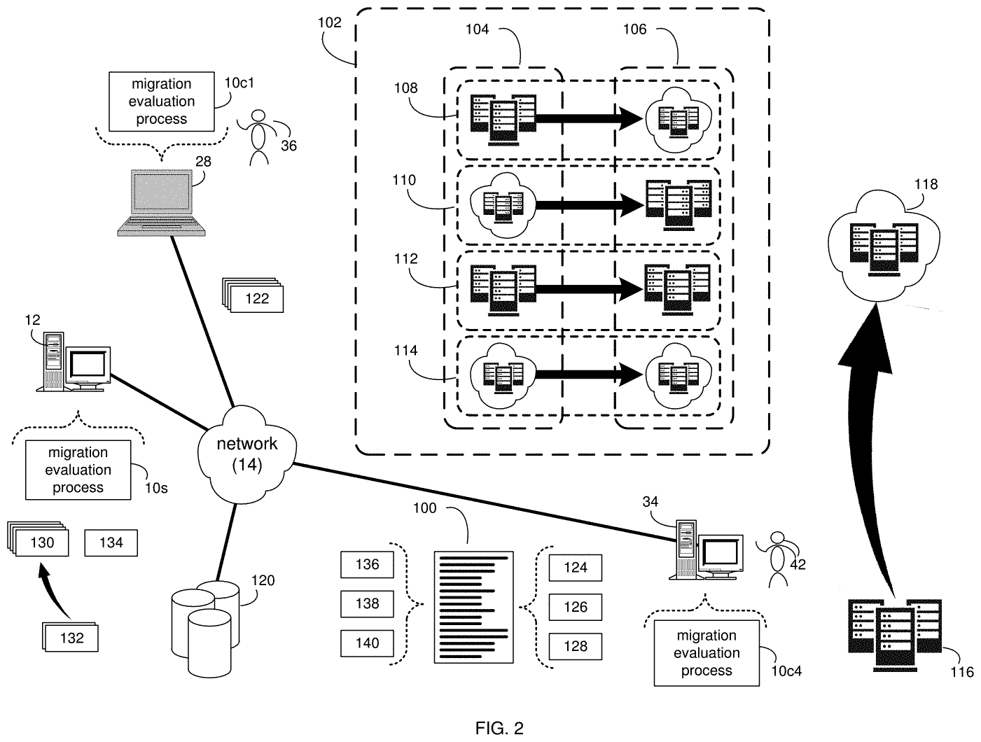

As will be discussed below in greater detail and referring also to FIG. 2, migration evaluation process 10 may be configured to enable the generation of a migration assessment (e.g., migration assessment 100) concerning a potential migration event (e.g., potential migration event 102) from a source workload (e.g., source workload 104) to a target workload (e.g., target workload 106).

Specific examples of such a potential migration event (e.g., potential migration event 102) may include but are not limited to:
on-premise to in-cloud migration event 108 in which an on-premise workload (e.g., source workload 104), such as on-premise software (e.g., operating systems/applications), on-premise databases (e.g., database records/data systems/data structures) and/or on-premise infrastructure (e.g., computers/servers/switches/routers/firewalls) is migrated to an in-cloud workload (e.g., target workload 106), such as in-cloud software (e.g., operating systems/applications), in-cloud databases (e.g., database records/data systems/data structures) and/or in-cloud infrastructure (e.g., computers/servers/switches/routers/firewalls);
in-cloud to on-premise migration event 110 in which an in-cloud workload (e.g., source workload 104), such as in-cloud software (e.g., operating systems/applications), in-cloud databases (e.g., database records/data systems/data structures) and/or in-cloud infrastructure (e.g., computers/servers/switches/routers/firewalls) is migrated to an on-premise workload (e.g., target workload 106), such as on-premise software (e.g., operating systems/applications), on-premise databases (e.g., database records/data systems/data structures) and/or on-premise infrastructure (e.g., computers/servers/switches/routers/firewalls);
on-premise to on-premise migration event 112 in which an on-premise workload (e.g., source workload 104), such as on-premise software (e.g., operating systems/applications), on-premise databases (e.g., database records/data systems/data structures) and/or on-premise infrastructure (e.g., computers/servers/switches/routers/firewalls) is migrated to another on-premise workload (e.g., target workload 106), such as on-premise software (e.g., operating systems/applications), on-premise databases (e.g., database records/data systems/data structures) and/or on-premise infrastructure (e.g., computers/servers/switches/routers/firewalls); and
in-cloud to in-cloud migration event 114 in which an in-cloud workload (e.g., source workload 104), such as in-cloud software (e.g., operating systems/applications), in-cloud databases (e.g., database records/data systems/data structures) and/or in-cloud infrastructure (e.g., computers/servers/switches/routers/firewalls) is migrated to another in-cloud workload (e.g., target workload 106), such as in-cloud software (e.g., operating systems/applications), in-cloud databases (e.g., database records/data systems/data structures) and/or in-cloud infrastructure (e.g., computers/servers/switches/routers/firewalls).

Additionally, the potential migration event (e.g., potential migration event 102) may concern one or more of: an application migration event; a database migration event; and an infrastructure migration event, wherein:
an application migration event may be a migration event in which software (e.g., operating systems/applications) of a client (e.g., user 42) is migrated from a source workload (e.g., source workload 104) to a target workload (e.g., target workload 106);
a database migration event may be a migration event in which databases (e.g., database records/data systems/data structures) of a client (e.g., user 42) are migrated from a source workload (e.g., source workload 104) to a target workload (e.g., target workload 106); and
an infrastructure migration event may be a migration event in which infrastructure (e.g., computers/servers/switches/routers/firewalls) of a client (e.g., user 42) is migrated from a source workload (e.g., source workload 104) to a target workload (e.g., target workload 106).

For the following example, assume that a client (e.g., user 42) has an on-premise workload (e.g., workload 116 that includes on-premise software (e.g., operating systems/applications), on-premise databases (e.g., database records/data systems/data structures) and on-premise infrastructure (e.g., computers/servers/switches/routers/firewalls)) that user 42 is considering migrating to an in-cloud workload (e.g., workload 118 that includes in-cloud software (e.g., operating systems/applications), in-cloud databases (e.g., database records/data systems/data structures) and in-cloud infrastructure (e.g., computers/servers/switches/routers/firewalls)). Accordingly, a representative (e.g., user 36) of a company (e.g., Mythics of Virginia Beach, Va.) that performs such (in this example) on-premise to in-cloud migrations may utilize migration evaluation process 10 in conjunction with rules engine 120 to gather migration information (e.g., migration information 122) from user 42 so that a migration assessment (e.g., migration assessment 100) may be generated and provided to user 42, thus enabling user 42 to make an informed decision (with respect to timing/price/options) concerning such an on-premise to in-cloud migration.

As will be discussed below in greater detail, the migration information (e.g., migration information 122) may include one or more of: source workload information; target workload information; application information; database information; infrastructure information; redundancy information; high-availability information; performance information; data migration information; migration event timeline information; environment information; and post-migration maintenance information, wherein:
source workload information, examples of which may include but are not limited to information concerning source software (e.g., operating systems/applications), source databases (e.g., database records/data systems/data structures) and/or source infrastructure (e.g., computers/servers/switches/routers/firewalls) included within the source workload (e.g., source workload 104);
target workload information, examples of which may include but are not limited to information concerning target software (e.g., operating systems/applications), target databases (e.g., database records/data systems/data structures) and/or target infrastructure (e.g., computers/servers/switches/routers/firewalls) included within the target workload (e.g., target workload 106);
application information, examples of which may include but are not limited to information concerning the source software (e.g., operating systems/applications) included within the source workload (e.g., source workload 104) and/or the target software (e.g., operating systems/applications) included within the target workload (e.g., target workload 106);
database information, examples of which may include but are not limited to information concerning the source databases (e.g., database records/data systems/data structures) included within the source workload (e.g., source workload 104) and/or the target databases (e.g., database records/data systems/data structures) included within the target workload (e.g., target workload 106);
infrastructure information, examples of which may include but are not limited to information concerning the source infrastructure (e.g., computers/servers/switches/routers/firewalls) included within the source workload (e.g., source workload 104) and/or the target infrastructure (e.g., computers/servers/switches/routers/firewalls) included within the target workload (e.g., target workload 106);
redundancy information, examples of which may include but are not limited to information concerning the source redundancy (e.g., of data/of systems/of applications/of infrastructure) included within the source workload (e.g., source workload 104) and/or the target redundancy (e.g., of data/of systems/of applications/of infrastructure) included within the target workload (e.g., target workload 106);
high-availability information, examples of which may include but are not limited to information concerning the source availability levels (e.g., of data/of systems/of applications/of infrastructure) included within the source workload (e.g., source workload 104) and/or the target availability levels (e.g., of data/of systems/of applications/of infrastructure) included within the target workload (e.g., target workload 106);
performance information, examples of which may include but are not limited to information concerning the source performance levels (e.g., of data/of systems/of applications/of infrastructure) included within the source workload (e.g., source workload 104) and/or the target performance levels (e.g., of data/of systems/of applications/of infrastructure) included within the target workload (e.g., target workload 106);
data migration information, examples of which may include but are not limited to information concerning who is going to migrate the client's data (e.g., database records/data systems/data structures) from the source workload (e.g., source workload 104) to the target workload (e.g., target workload 106);
migration event timeline information, examples of which may include but are not limited to information concerning the desired (or anticipated) timeline (or timeframe) for effectuating the migration from a source workload (e.g., source workload 104) to a target workload (e.g., target workload 106);
environment information, examples of which may include but are not limited to information concerning the source environment (e.g., a developer environment, a test environment, a production environment, a UAT environment) of the source workload (e.g., source workload 104) and/or the target environment (e.g., a developer environment, a test environment, a production environment, a UAT environment) of the target workload (e.g., target workload 106); and
post-migration maintenance information, examples of which may include but are not limited to information concerning who is going to maintain the client's in-cloud software (e.g., operating systems/applications), in-cloud databases (e.g., database records/data systems/data structures) and in-cloud infrastructure (e.g., computers/servers/switches/routers/firewalls)).

As will be discussed below in greater detail, migration assessment 100 may include one or more of platform migration assessment 124; data migration assessment 126; and post-migration maintenance assessment 128, wherein:
platform migration assessment 124 may provide an estimated cost/timeline for migrating a platform (e.g., software, databases and/or infrastructure) of the client (e.g., user 42) from a source workload (e.g., source workload 104) to a target workload (e.g., target workload 106);
data migration assessment 126 may provide an estimated cost/timeline for migrating data (e.g., software data and/or database data) of the client (e.g., user 42) from a source workload (e.g., source workload 104) to a target workload (e.g., target workload 106); and
post-migration maintenance assessment 128 may provide an estimated cost for maintaining the platform (e.g., software, databases and/or infrastructure) and/or the data (e.g., software data and/or database data) for the client (e.g., user 42) on the target workload (e.g., target workload 106).

Migration Evaluation Process Generally

As discussed above and for this example, assume that user 36 is a representative/employee of a company (e.g., Mythics of Virginia Beach, Va.) that performs migrations (e.g., on-premise to in-cloud, on-premise to on-premise, in-cloud to in-cloud and/or in-cloud to on-premise) and user 36 is working with a client (e.g., user 42) to get an assessment concerning migrating an on-premise workload (e.g., workload 116 that includes one or more of on-premise software (e.g., operating systems/applications), on-premise databases (e.g., database records/data systems/data structures) and on-premise infrastructure (e.g., computers/servers/switches/routers/firewalls)) to an in-cloud workload (e.g., workload 118 that includes one or more of in-cloud software (e.g., operating systems/applications), in-cloud databases (e.g., database records/data systems/data structures) and in-cloud infrastructure (e.g., computers/servers/switches/routers/firewalls)).

As will be discussed below in greater detail, when generating the migration assessment (e.g., migration assessment 100), the representative (e.g., user 36) may utilize one or more of a plurality of migration scenarios (e.g., plurality of migration scenarios 130) within a migration platform (e.g., a migration platform offered by Mythics of Virginia Beach, Va.).

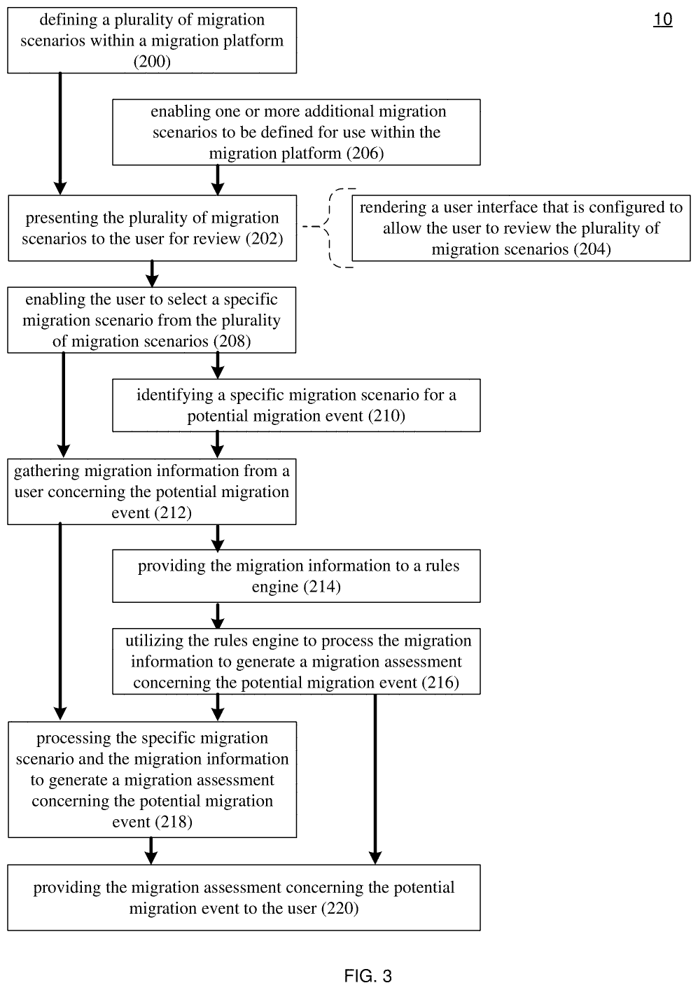

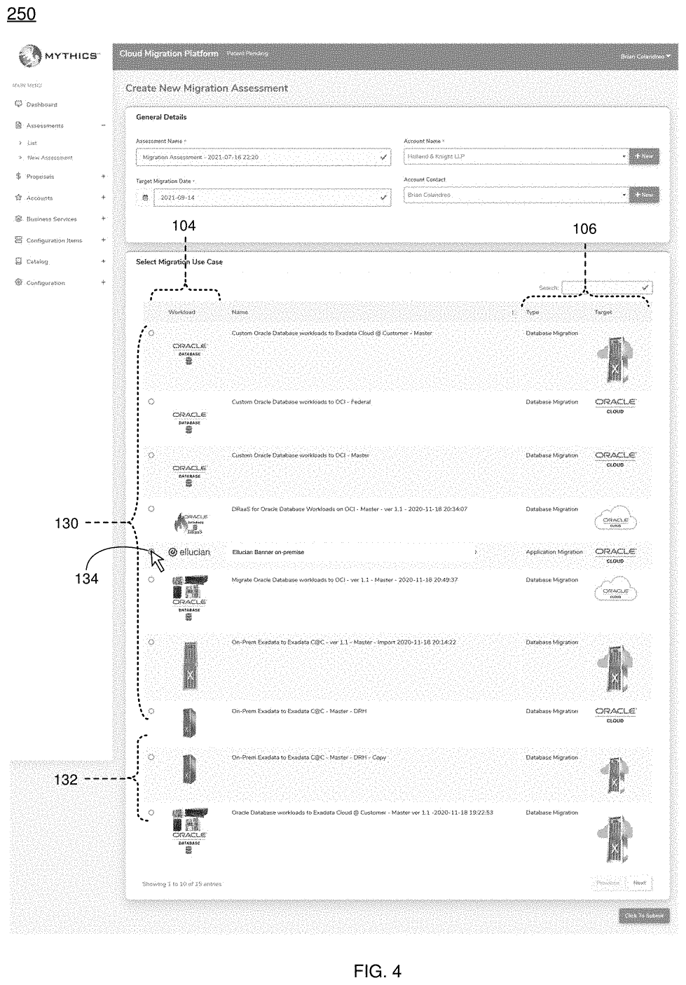

Accordingly and referring also to FIGS. 3-4, migration evaluation process 10 may define 200 the plurality of migration scenarios (e.g., plurality of migration scenarios 130) within the migration platform (e.g., a migration platform offered by Mythics of Virginia Beach, Va.) and may present 202 the plurality of migration scenarios (e.g., plurality of migration scenarios 130) to the user (e.g., user 36) for review. This plurality of migration scenarios (e.g., plurality of migration scenarios 130) defined within the migration platform (e.g., the migration platform offered by Mythics of Virginia Beach, Va.) may be generated by e.g., solution architects and/or technical experts in the migration space, such as representatives (e.g., users 36, 38, 40) of the company (e.g., Mythics of Virginia Beach, Va.) that effectuates such migrations. For example, each migration scenario defined within plurality of migration scenarios 130 may define a source workload (e.g., source workload 104) and a target workload (e.g., target workload 106), wherein the user (e.g., user 36) of migration evaluation process 10 may select the appropriate migration scenario based upon the migration being performed.

As will be discussed below in greater detail, once a specific migration scenario (e.g., specific migration scenario 134) is selected by (in this example) user 36 working with user 42, migration evaluation process 10 may utilize (in this example) the specific migration scenario (e.g., specific migration scenario 134) to obtain migration information 122 so that the migration assessment (e.g., migration assessment 100) may be generated.

When presenting 202 the plurality of migration scenarios (e.g., plurality of migration scenarios 130) to a user (e.g., user 36) for review, migration evaluation process 10 may render 204 a user interface (e.g., user interface 250) that is configured to allow the user (e.g., user 36) to review the plurality of migration scenarios (e.g., plurality of migration scenarios 130). User interface 250 rendered 204 by migration evaluation process 10 may be configured to be utilized/viewable on a variety of devices (e.g., client electronic devices 28, 30, 32, 34), examples of which may include but are not limited to a smartphone (not shown), a personal digital assistant (not shown), a tablet computer (not shown), laptop computers 28, 30, 32, personal computer 34, a notebook computer (not shown), a server computer (not shown), a gaming console (not shown) and a dedicated network device (not shown).

Migration evaluation process 10 may enable 206 one or more additional migration scenarios (e.g., additional migration scenarios 132) to be defined for use within the migration platform (e.g., a migration platform offered by Mythics of Virginia Beach, Va.). For example and upon defining the one or more additional migration scenarios (e.g., additional migration scenarios 132), these one or more additional migration scenarios (e.g., additional migration scenarios 132) may be included within (e.g., incorporated into) the plurality of migration scenarios (e.g., plurality of migration scenarios 130).

Migration evaluation process 10 may enable 208 the user (e.g., user 36) to select a specific migration scenario (e.g., specific migration scenario 134) from the plurality of migration scenarios (e.g., plurality of migration scenarios 130) for a potential migration event (e.g., potential migration event 102) from a source workload (e.g., source workload 104) to a target workload (e.g., target workload 106). For example, assume that the client (e.g., user 42) for which the potential migration event (e.g., potential migration event 102) may be performed currently uses Ellucian Banner on-Premise™ (e.g., source workload 116) and wishes to migrate to Ellucian Banner in Oracle Cloud™ (e.g., target workload 118). Accordingly and in such a situation, user 36 (e.g., the representative) may select a specific migration scenario (e.g., specific migration scenario 134) that defines Ellucian Banner on-Premise™ as source workload 116 and Ellucian Banner in Oracle Cloud™ as target workload 118, thus identifying 210 the specific migration scenario (e.g., specific migration scenario 134) for the potential migration event (e.g., potential migration event 102). As discussed above, this potential migration event (e.g., potential migration event 102) may concern one or more of: an application migration event; a database migration event; and an infrastructure migration event.

As will be discussed below in greater detail, once the specific migration scenario (e.g., specific migration scenario 134) is identified 210, migration evaluation process 10 may gather 212 migration information (e.g., migration information 122) from the user (e.g., user 36) concerning the potential migration event (e.g., potential migration event 102). As discussed above, this migration information (e.g., migration information 122) may be gathered 212 via consultation/discussion with the client (e.g., user 42).

Migration evaluation process 10 may then process 218 the specific migration scenario (e.g., specific migration scenario 134) and the migration information (e.g., migration information 122) to generate a migration assessment (e.g., migration assessment 100) concerning the potential migration event (e.g., potential migration event 102). As discussed above, the migration information (e.g., migration information 122) may include one or more of: source workload information; target workload information; application information; database information; infrastructure information; redundancy information; high-availability information; performance information; data migration information; migration event timeline information; environment information; and post-migration maintenance information, wherein:
source workload information, examples of which may include but are not limited to information concerning source software (e.g., operating systems/applications), source databases (e.g., database records/data systems/data structures) and/or source infrastructure (e.g., computers/servers/switches/routers/firewalls) included within the source workload (e.g., source workload 104);
target workload information, examples of which may include but are not limited to information concerning target software (e.g., operating systems/applications), target databases (e.g., database records/data systems/data structures) and/or target infrastructure (e.g., computers/servers/switches/routers/firewalls) included within the target workload (e.g., target workload 106);
application information, examples of which may include but are not limited to information concerning the source software (e.g., operating systems/applications) included within the source workload (e.g., source workload 104) and/or the target software (e.g., operating systems/applications) included within the target workload (e.g., target workload 106);
database information, examples of which may include but are not limited to information concerning the source databases (e.g., database records/data systems/data structures) included within the source workload (e.g., source workload 104) and/or the target databases (e.g., database records/data systems/data structures) included within the target workload (e.g., target workload 106);
infrastructure information, examples of which may include but are not limited to information concerning the source infrastructure (e.g., computers/servers/switches/routers/firewalls) included within the source workload (e.g., source workload 104) and/or the target infrastructure (e.g., computers/servers/switches/routers/firewalls) included within the target workload (e.g., target workload 106);
redundancy information, examples of which may include but are not limited to information concerning the source redundancy (e.g., of data/of systems/of applications/of infrastructure) included within the source workload (e.g., source workload 104) and/or the target redundancy (e.g., of data/of systems/of applications/of infrastructure) included within the target workload (e.g., target workload 106);
high-availability information, examples of which may include but are not limited to information concerning the source availability levels (e.g., of data/of systems/of applications/of infrastructure) included within the source workload (e.g., source workload 104) and/or the target availability levels (e.g., of data/of systems/of applications/of infrastructure) included within the target workload (e.g., target workload 106);
performance information, examples of which may include but are not limited to information concerning the source performance levels (e.g., of data/of systems/of applications/of infrastructure) included within the source workload (e.g., source workload 104) and/or the target performance levels (e.g., of data/of systems/of applications/of infrastructure) included within the target workload (e.g., target workload 106);
data migration information, examples of which may include but are not limited to information concerning who is going to migrate the client's data (e.g., database records/data systems/data structures) from the source workload (e.g., source workload 104) to the target workload (e.g., target workload 106);
migration event timeline information, examples of which may include but are not limited to information concerning the desired (or anticipated) timeline (or timeframe) for effectuating the migration from a source workload (e.g., source workload 104) to a target workload (e.g., target workload 106);
environment information, examples of which may include but are not limited to information concerning the source environment (e.g., a developer environment, a test environment, a production environment, a UAT environment) of the source workload (e.g., source workload 104) and/or the target environment (e.g., a developer environment, a test environment, a production environment, a UAT environment) of the target workload (e.g., target workload 106); and
post-migration maintenance information, examples of which may include but are not limited to information concerning who is going to maintain the client's in-cloud software (e.g., operating systems/applications), in-cloud databases (e.g., database records/data systems/data structures) and in-cloud infrastructure (e.g., computers/servers/switches/routers/firewalls)).

As also discussed above, migration assessment 100 may include one or more of platform migration assessment 124; data migration assessment 126; and post-migration maintenance assessment 128, wherein:
platform migration assessment 124 may provide an estimated cost/timeline for migrating a platform (e.g., software, databases and/or infrastructure) of the client (e.g., user 42) from a source workload (e.g., source workload 104) to a target workload (e.g., target workload 106);
data migration assessment 126 may provide an estimated cost/timeline for migrating data (e.g., software data and/or database data) of the client (e.g., user 42) from a source workload (e.g., source workload 104) to a target workload (e.g., target workload 106); and
post-migration maintenance assessment 128 may provide an estimated cost for maintaining the platform (e.g., software, databases and/or infrastructure) and/or the data (e.g., software data and/or database data) for the client (e.g., user 42) on the target workload (e.g., target workload 106).

The specific migration scenario (e.g., specific migration scenario 134) and the migration information (e.g., migration information 122) may be based, at least in part, upon knowledge/best practices defined within a rules engine (e.g., rules engine 120). As discussed above, assume that the client (e.g., user 42) for which the potential migration event (e.g., potential migration event 102) may be performed currently uses Ellucian Banner on-Premise™ (e.g., source workload 116) and wishes to migrate to Ellucian Banner in Oracle Cloud™ (e.g., target workload 118). Accordingly and in such a situation, user 36 (e.g., the representative) may select a specific migration scenario (e.g., specific migration scenario 134) that defines Ellucian Banner on-Premise™ as source workload 116 and Ellucian Banner in Oracle Cloud™ as target workload 118, thus identifying 210 the specific migration scenario (e.g., specific migration scenario 134) for the potential migration event (e.g., potential migration event 102).

Accordingly and as will be discussed below in greater detail, specific migration scenario 134 may be configured to request any and all information required to generate migration assessment 100. Specifically, as user 36 (e.g., the representative) works their way through the specific migration scenario (e.g., specific migration scenario 134) alone or in combination with the client (e.g., user 42), the migration information (e.g., migration information 122) gathered 212 by migration evaluation process 10 may be provided 214 to the rules engine (e.g., rules engine 120), wherein migration evaluation process 10 may utilize 216 the rules engine (e.g., rules engine 120) to process the migration information (e.g., migration information 122) to generate the migration assessment (e.g., migration assessment 100) concerning the potential migration event (e.g., potential migration event 102).

The rules engine (e.g., rules engine 120) may be configured to memorialize the knowledge of solution architects/technical experts (e.g., users 36, 38, 40) in the workload migration space and/or memorialize information concerning a plurality of service providers is such workload migration space. For example, such solution architects/technical experts (e.g., users 36, 38, 40) may define the requirements of various source workloads (e.g., source workloads 104) and/or target workloads (e.g., target workloads 106).

Specifically and with respect to the above-stated example (in which Ellucian Banner on-Premise™ is source workload 116 and Ellucian Banner in Oracle Cloud™ is target workload 118), the solution architects/technical experts (e.g., users 36, 38, 40) may know what information is required (e.g., what questions should be asked) to ascertain the current configuration of source workload 104 (e.g., Ellucian Banner on-Premise™) with respect to the client (e.g., user 42), wherein this information (e.g., some or all of migration information 122) may be provided 214 to and/or utilized 216 by the rules engine (e.g., rules engine 120) for use when generating migration assessment 100. Further, the solution architects/technical experts (e.g., users 36, 38, 40) may know what information is required (e.g., what questions should be asked) to ascertain the desired configuration of target workload 106 (e.g., Ellucian Banner in Oracle Cloud™) with respect to the client (e.g., user 42), wherein this information (e.g., some or all of migration information 122) may be provided 214 to and/or utilized 216 by the rules engine (e.g., rules engine 120) for use when generating migration assessment 100.

Generally speaking, once the above-described migration information (e.g., migration information 122) is gathered 212 and/or provided 214 to and/or utilized 216 by rules engine 120, the specific migration scenario (e.g., specific migration scenario 134) and the migration information (e.g., migration information 122) may be processed 218 to generate the migration assessment (e.g., migration assessment 100) concerning the potential migration event (e.g., potential migration event 102). Once migration assessment 100 is generated, migration evaluation process 10 may provide 220 the migration assessment (e.g., migration assessment 100) concerning the potential migration event (e.g., potential migration event 102) to the user (e.g., user 36). For example, migration evaluation process 10 may render the migration assessment (e.g., migration assessment 100) within user interface 250 for review by user 36 and/or user 42, enable user 36 and/or user 42 to download the migration assessment (e.g., migration assessment 100), and/or email the migration assessment (e.g., migration assessment 100) to user 36 and/or user 42.

Migration Evaluation Process Use Case(s)

The following discussion is intended to illustrate the various ways in which migration evaluation process 10 may be utilized to generate the migration assessment (e.g., migration assessment 100). Accordingly, the following discussion is for illustrative purposes only and is not intended to be a limitation of this disclosure, as other use cases are possible and are considered to be within the scope of this disclosure.

As discussed above, migration evaluation process 10 may define 200 the plurality of migration scenarios (e.g., plurality of migration scenarios 130) within the migration platform (e.g., a migration platform offered by Mythics of Virginia Beach, Va.) and may present 202 the plurality of migration scenarios (e.g., plurality of migration scenarios 130) to the user (e.g., user 36) for review, wherein migration evaluation process 10 may:
render 204 user interface 250 that is configured to allow the user (e.g., user 36) to review the plurality of migration scenarios (e.g., plurality of migration scenarios 130); and
enable 208 the user (e.g., user 36) to select a specific migration scenario (e.g., specific migration scenario 134) from the plurality of migration scenarios (e.g., plurality of migration scenarios 130) for a potential migration event (e.g., potential migration event 102) from a source workload (e.g., source workload 104) to a target workload (e.g., target workload 106)

As discussed above, assume that the client (e.g., user 42) for which the potential migration event (e.g., potential migration event 102) may be performed currently uses Ellucian Banner on-Premise™ (e.g., source workload 116) and wishes to migrate to Ellucian Banner in Oracle Cloud™ (e.g., target workload 118). Accordingly and in such a situation, user 36 (e.g., the representative) may select (e.g., by tapping or via a mouse click) a specific migration scenario (e.g., specific migration scenario 134) that defines Ellucian Banner on-Premise™ as source workload 116 and Ellucian Banner in Oracle Cloud™ as target workload 118, thus identifying 210 the specific migration scenario (e.g., specific migration scenario 134) for the potential migration event (e.g., potential migration event 102). Migration evaluation process 10 may then gather 212 migration information (e.g., migration information 122) from the user (e.g., user 36) concerning the potential migration event (e.g., potential migration event 102).

Specifically and with respect to gathering 212 the migration information (e.g., migration information 122) from the user (e.g., user 36) concerning the potential migration event (e.g., potential migration event 102), migration evaluation process 10 may render various screens to obtain the migration information (e.g., migration information 122).

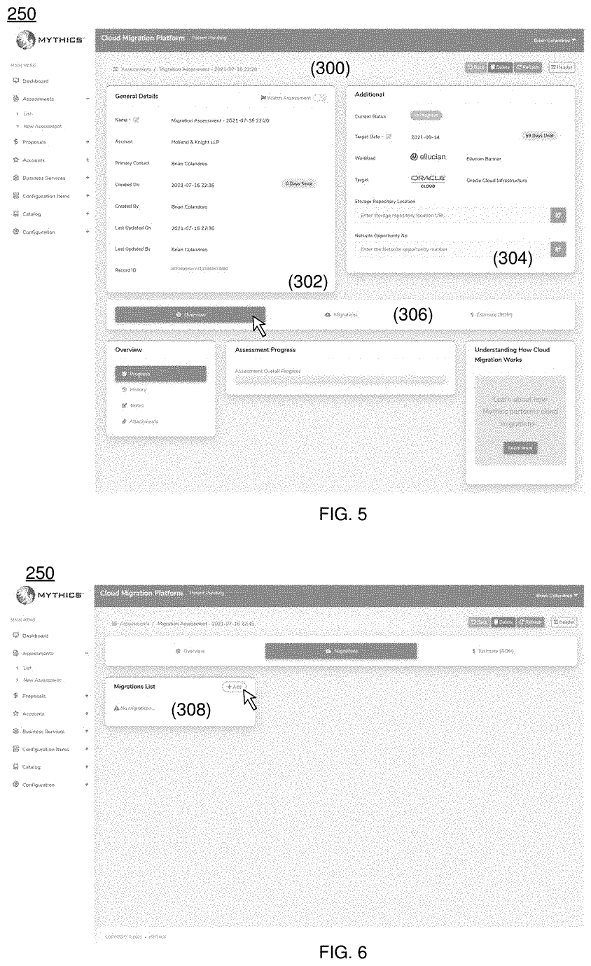

Referring also to FIG. 5, upon selecting (via tapping or a mouse click) specific migration scenario 134 (as shown in FIG. 4), migration evaluation process 10 may render overview screen 300 (within user interface 250) for specific migration scenario 134 (e.g., Ellucian Banner on-Premise™ [symbol] Ellucian Banner in Oracle Cloud™). Overview screen 300 may include various portions, examples of which may include but are not limited to bibliographic portion 302, technical portion 304 and status portion 306. Status portion 306 may include various tabs, examples of which may include but are not limited to “Overview” tab, “Migration” tab and “Estimate” tab. Upon selecting (via tapping or a mouse click) the “Overview” tab, migration evaluation process 10 may render overview information within and status portion 306.

Referring also to FIG. 6, upon selecting (via tapping or a mouse click) “Migration” tab (as shown in FIG. 5), migration evaluation process 10 may render migration list 308 (within user interface 250) that enables the user (e.g., user 36) to define the specifics of one or more discrete migration tasks for specific migration scenario 134 (e.g., Ellucian Banner on-Premise™ [symbol] Ellucian Banner in Oracle Cloud™). For example and to add a discrete migration task, the user (e.g., user 36) may select (via tapping or a mouse click) the “+Add” button, wherein a plurality of discrete migration tasks may be defined.

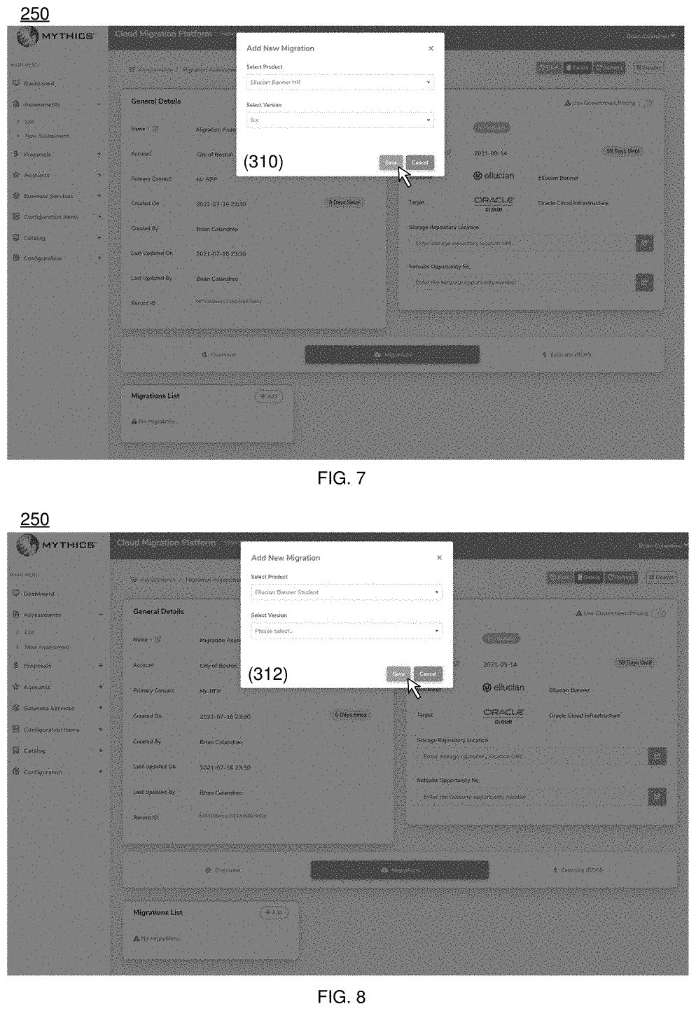

Referring also to FIG. 7, upon selecting (via tapping or a mouse click) the “+Add” button (as shown in FIG. 6), migration evaluation process 10 may render migration details window 310 (within user interface 250) that enables the user (e.g., user 36) to define the specifics of (in this example) a first discrete migration task. Within migration details window 310, the user (e.g., user 36) may define the details (e.g., product name, product version, etc.) of the product to be migrated for specific migration scenario 134 (e.g., Ellucian Banner on-Premise™ [symbol] Ellucian Banner in Oracle Cloud™) and select (via tapping or a mouse click) the “Save” button.

Referring also to FIG. 8, in the event that an additional discrete migration tasks needs to be defined for specific migration scenario 134 (e.g., Ellucian Banner on-Premise™ [symbol] Ellucian Banner in Oracle Cloud™), the user (e.g., user 36) may again select (via tapping or a mouse click) the “+Add” button (as shown in FIG. 6) and migration evaluation process 10 may render migration details window 312 (within user interface 250) that enables the user (e.g., user 36) to define the specifics of (in this example) a second discrete migration task. Within migration details window 312, the user (e.g., user 36) may define the details (e.g., product name, product version, etc.) of the product to be migrated for specific migration scenario 134 (e.g., Ellucian Banner on-Premise™ [symbol] Ellucian Banner in Oracle Cloud™) and select (via tapping or a mouse click) the “Save” button.

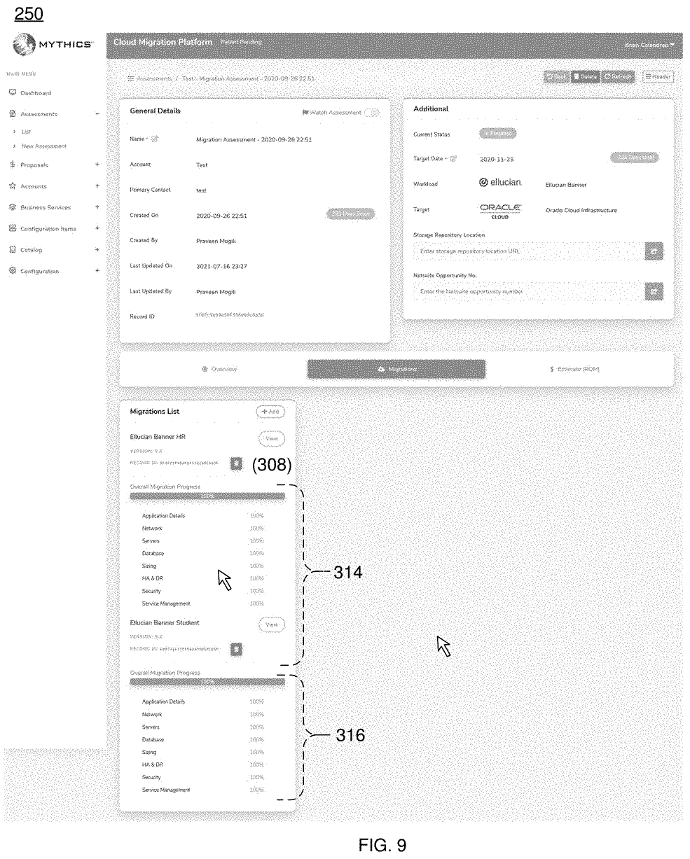

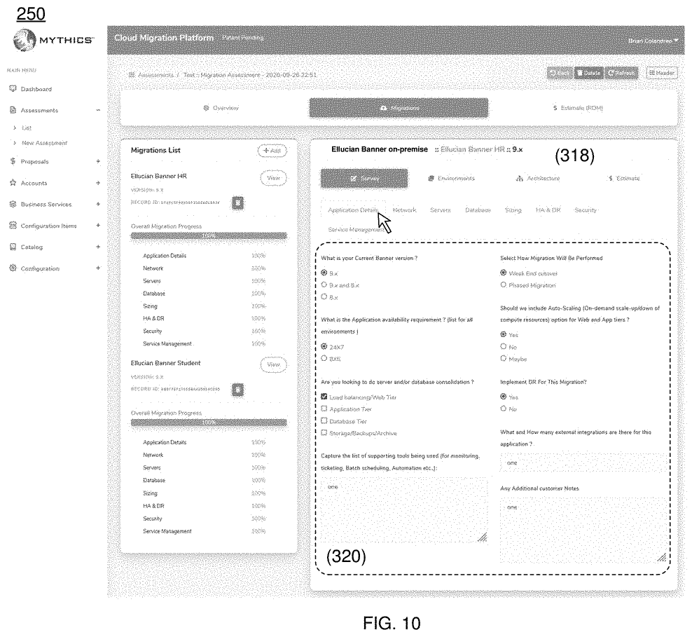

Referring also to FIG. 9, upon defining (in this example) two discrete migration tasks (as shown in FIGS. 7-8), migration evaluation process 10 may update migration list 308 (within user interface 250) to define these migration tasks (e.g., mitigation tasks 314, 316). Migration evaluation process 10 may enable the user (e.g., user 36) to provide information for each of these migration tasks (e.g., mitigation tasks 314, 316). For the following discussion, the manner in which migration evaluation process 10 enables the user (e.g., user 36) to provide migration information (e.g., migration information 122) for mitigation task 314 is illustrated. However, it is understood that this is for illustrative purposes only, as migration evaluation process 10 may utilize similar methodologies to enable the user (e.g., user 36) to provide the migration information (e.g., migration information 122) for other migration tasks (e.g., mitigation task 316).

Referring also to FIG. 10 and upon selecting (via tapping or a mouse click) mitigation task 314 (as shown in FIG. 9), migration evaluation process 10 may render migration task detail window 318 that defines the details for mitigation task 314. Migration task detail window 318 may include various tabs, examples of which may include but are not limited to “Survey” tab, “Environment” tab, “Architecture” tab and “Estimate” tab, wherein each of these tabs (e.g., “Survey” tab, “Environment” tab, “Architecture” tab and “Estimate” tab) may include one or more subtabs. For example, “Survey” tab is shown to include “Application Details” subtab, “Network” subtab, “Servers” subtab, “Database” subtab, “Sizing” subtab, “HA & DR” subtab, “Security” subtab, and “Service Management” subtab. Upon selecting (via tapping or a mouse click) any of these subtabs, migration evaluation process 10 may render the questions/inquiries associated with that subtab to effectuate the gathering of a portion of the migration information (e.g., migration information 122) for the potential migration event (e.g., potential migration event 102) from the user (e.g., user 36). For example and upon selecting (via tapping or a mouse click) the “Survey” tab and then the “Application Details” subtab, migration evaluation process 10 may render the questions/inquiries associated with the “Application Details” subtab within inquiry window 320. The user (e.g., user 36) may then respond to such “Application Details” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Application Details” information may include but are not limited to information concerning application versions, application availability needs/performance requirements, consolidation needs/performance requirements, migration needs/performance requirements, scaling needs/performance requirements, and disaster recovery needs/performance requirements.

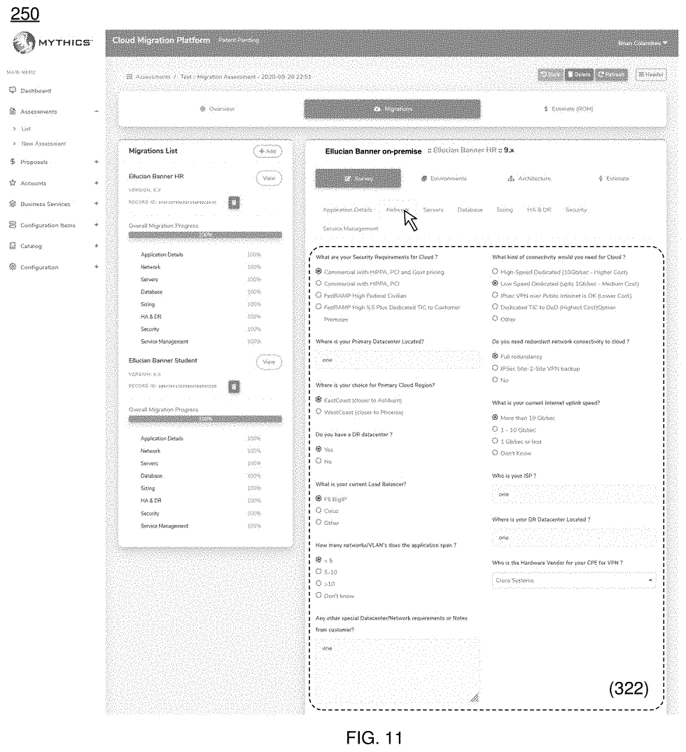

Referring also to FIG. 11 and upon selecting (via tapping or a mouse click) the “Survey” tab and then the “Network” subtab, migration evaluation process 10 may render the questions/inquiries associated with the “Network” subtab within inquiry window 322. The user (e.g., user 36) may then respond to such “Network” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Network” information may include but are not limited to information concerning security needs/performance requirements, data center location, cloud region location, disaster recovery status, load balancer status, application, connectivity needs/performance requirements, redundancy needs/performance requirements, internet uplink information, ISP information, disaster recover location and hardware vendor information.

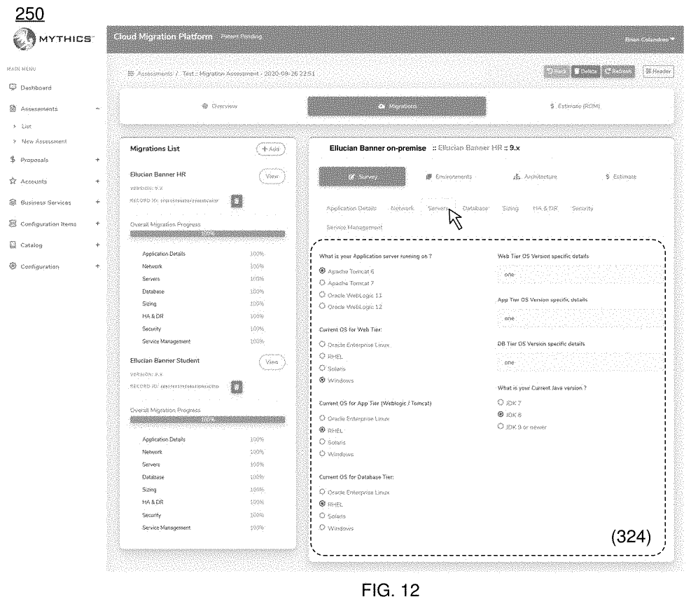

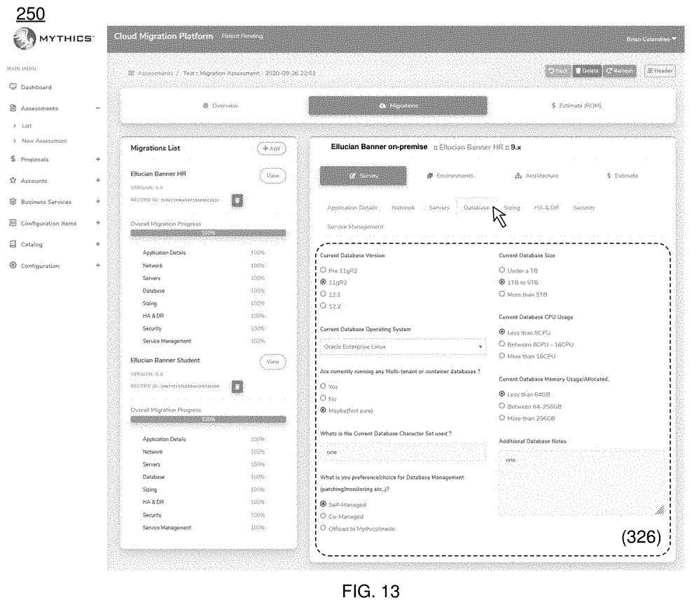

Referring also to FIG. 12 and upon selecting (via tapping or a mouse click) the “Survey” tab and then the “Servers” subtab, migration evaluation process 10 may render the questions/inquiries associated with the “Servers” subtab within inquiry window 324. The user (e.g., user 36) may then respond to such “Servers” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Servers” information may include but are not limited to information concerning application versions, operating system version information and Java version information.

Referring also to FIG. 13 and upon selecting (via tapping or a mouse click) the “Survey” tab and then the “Databases” subtab, migration evaluation process 10 may render the questions/inquiries associated with the “Databases” subtab within inquiry window 326. The user (e.g., user 36) may then respond to such “Databases” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Databases” information may include but are not limited to information concerning database versions, database operating systems, character set information, database management needs/performance requirements, database size information, database CPU usage information, and database memory usage.

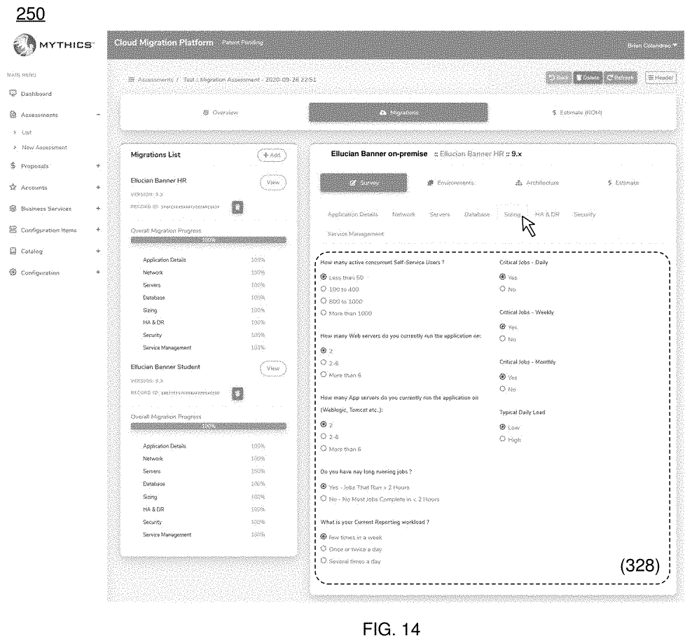

Referring also to FIG. 14 and upon selecting (via tapping or a mouse click) the “Survey” tab and then the “Sizing” subtab, migration evaluation process 10 may render the questions/inquiries associated with the “Sizing” subtab within inquiry window 328. The user (e.g., user 36) may then respond to such “Sizing” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Sizing” information may include but are not limited to information concerning active users, web server information, app server information, job information, reporting workload information, critical job information and daily load information.

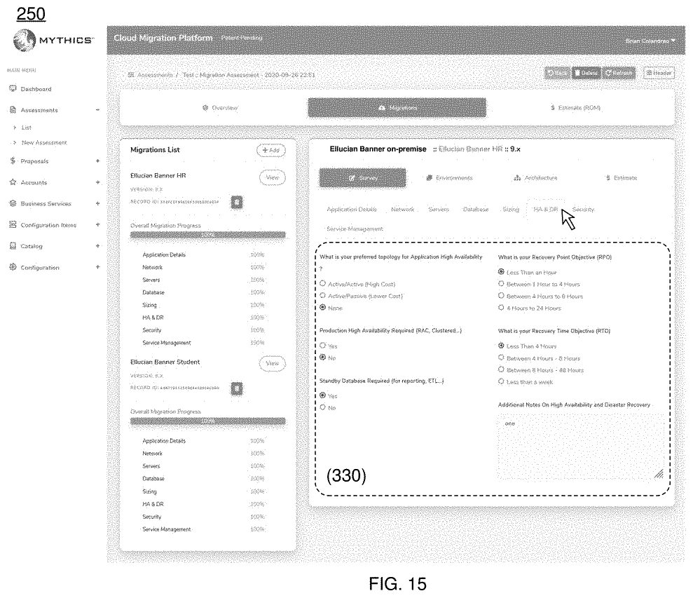

Referring also to FIG. 15 and upon selecting (via tapping or a mouse click) the “Survey” tab and then the “HA & DR” subtab, migration evaluation process 10 may render the questions/inquiries associated with the “HA & DR” subtab within inquiry window 330. The user (e.g., user 36) may then respond to such “HA & DR” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “HA & DR” information may include but are not limited to information concerning topology needs/performance requirements, production high availability needs/performance requirements, standby database needs/performance requirements, recovery point objective needs/performance requirements, and recovery time objective needs/performance requirements.

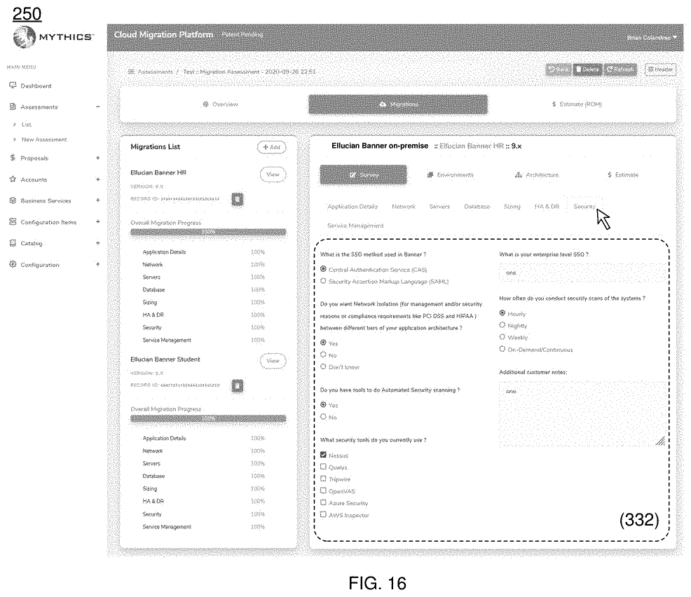

Referring also to FIG. 16 and upon selecting (via tapping or a mouse click) the “Survey” tab and then the “Security” subtab, migration evaluation process 10 may render the questions/inquiries associated with the “Security” subtab within inquiry window 332. The user (e.g., user 36) may then respond to such “Security” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Security” information may include but are not limited to information concerning SSO method needs/performance requirements, network isolation needs/performance requirements, automated security scanning needs/performance requirements, security tools needs/performance requirements, enterprise SSO needs/performance requirements, and security scan needs/performance requirements.

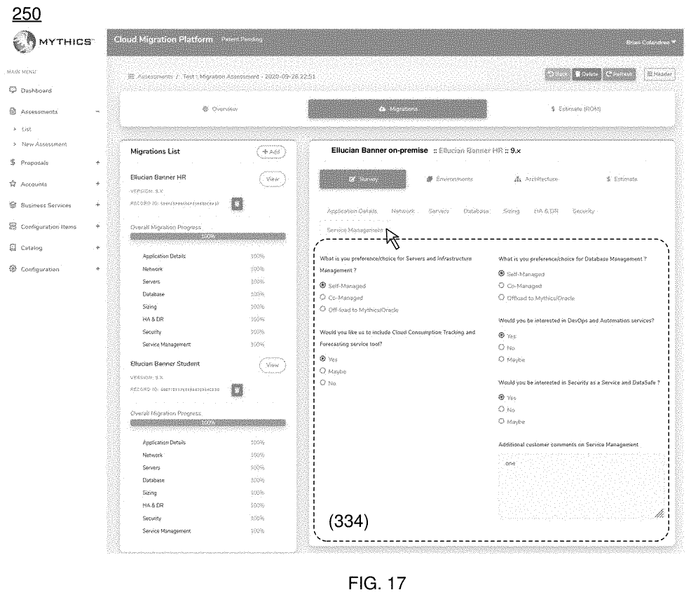

Referring also to FIG. 17 and upon selecting (via tapping or a mouse click) the “Survey” tab and then the “Service Management” subtab, migration evaluation process 10 may render the questions/inquiries associated with the “Service Management” subtab within inquiry window 334. The user (e.g., user 36) may then respond to such “Service Management” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). Examples of such “Service Management” information may include but are not limited to information concerning server and infrastructure management needs/performance requirements, cloud consumption tracking and forecasting needs/performance requirements, database management needs/performance requirements, DevOps and Automation needs/performance requirements, and security as a service/DataSafe needs/performance requirements.

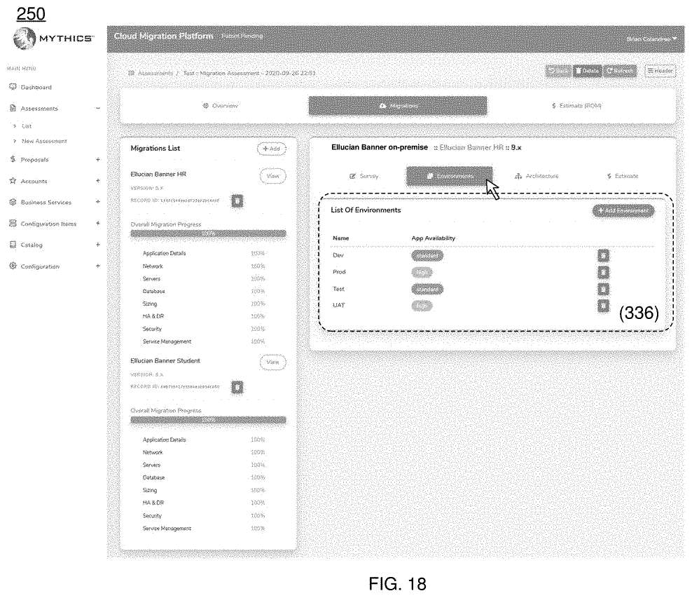

Referring also to FIG. 18 and upon selecting (via tapping or a mouse click) the “Environments” tab, which (in this illustrative example) does not have any subtabs, migration evaluation process 10 may render the questions/inquiries associated with the “Environments” tab within inquiry window 336. The user (e.g., user 36) may then respond to such “Environments” questions/inquiries (via e.g., the selection of predefined answers and/or the supplying of bespoke text-based answers), thus providing a portion of the migration information (e.g., migration information 122) required for migration evaluation process 10 to generate the migration assessment (e.g., migration assessment 100). As discussed above, examples of such “Environments” information may include but are not limited to information concerning the source environment (e.g., a developer environment, a test environment, a production environment, a UAT environment) of source workload 116 and/or the target environment (e.g., a developer environment, a test environment, a production environment, a UAT environment) of target workload 118.

Once the user (e.g., user 36) responds to all of the questions/inquiries associated with (in this illustrative example) “Survey” tab, “Environment” tab, “Architecture” tab and “Estimate” tab (and any related subtabs), the gathering 212 of the migration information (e.g., migration information 122) from the user (e.g., user 36) concerning the potential migration event (e.g., potential migration event 102) may be generally complete.

As some of the migration information (e.g., migration information 122) concerning the potential migration event (e.g., potential migration event 102) is based on the needs/performance requirements defined by the user (e.g., user 36, and/or user 42), migration assessment 100 may be generated without requiring the user (e.g., user 36, and/or user 42) to define the technical specifics of (in this example) target workload 118. For example, migration assessment 100 may be generated without requiring that the user (e.g., user 36, and/or user 42) define e.g., the quantity/type of servers, the quantity/type of switches, the quantity/type of firewalls, the quantity/type of routers, etc.

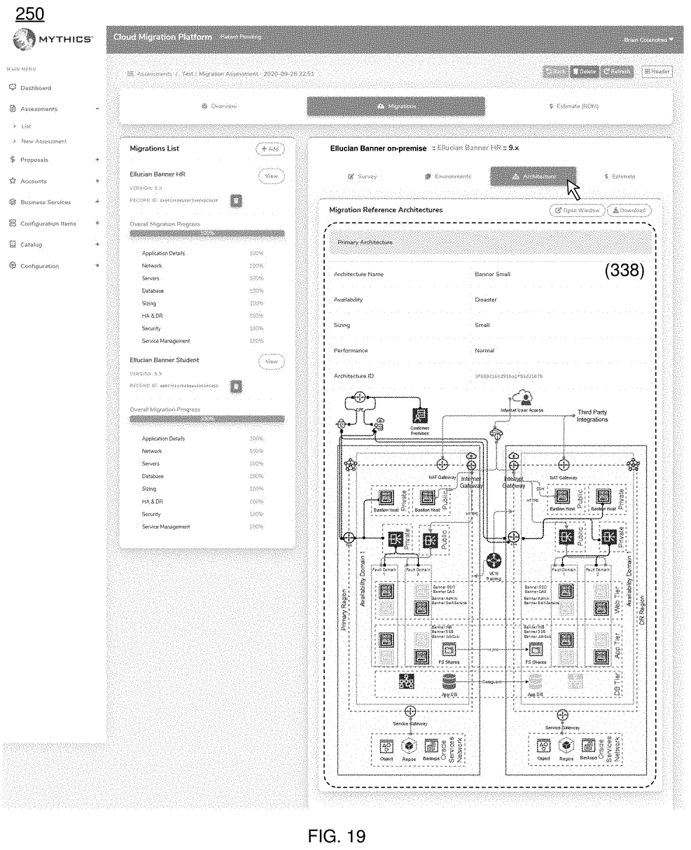

Accordingly and referring also to FIG. 19, upon selecting (via tapping or a mouse click) the “Architecture” tab, migration information 122 may be provided 214 to and/or utilized 216 by the rules engine (e.g., rules engine 120) to generate migration assessment 100. Accordingly, migration evaluation process 10 may render architecture window 338, which includes e.g., architecture information and/or one or more network maps.

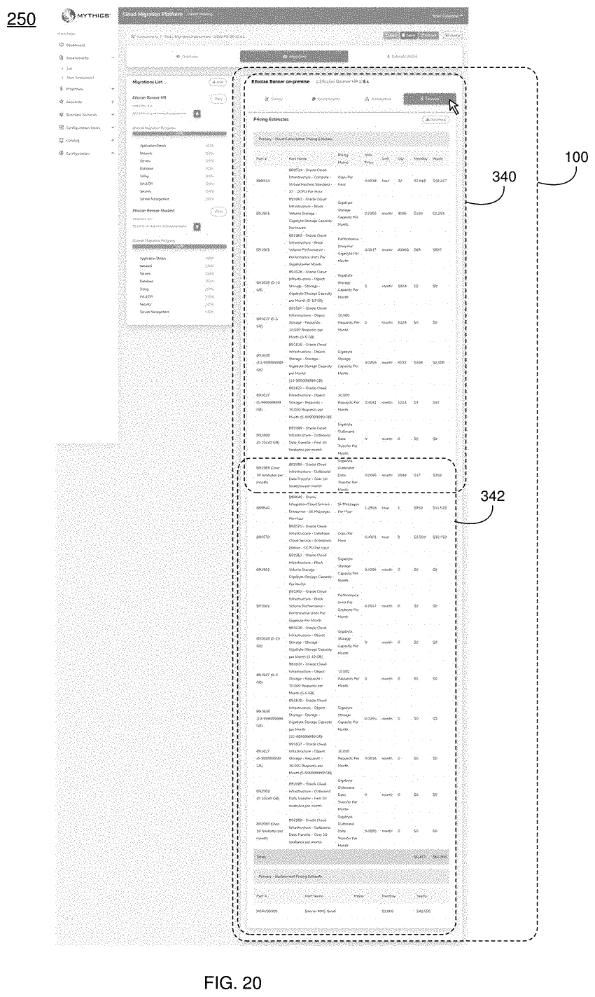

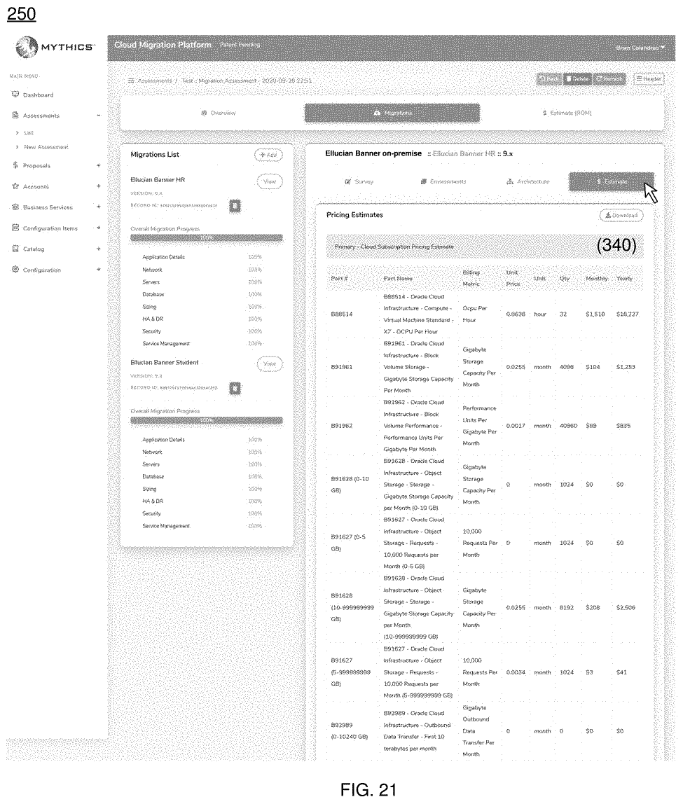

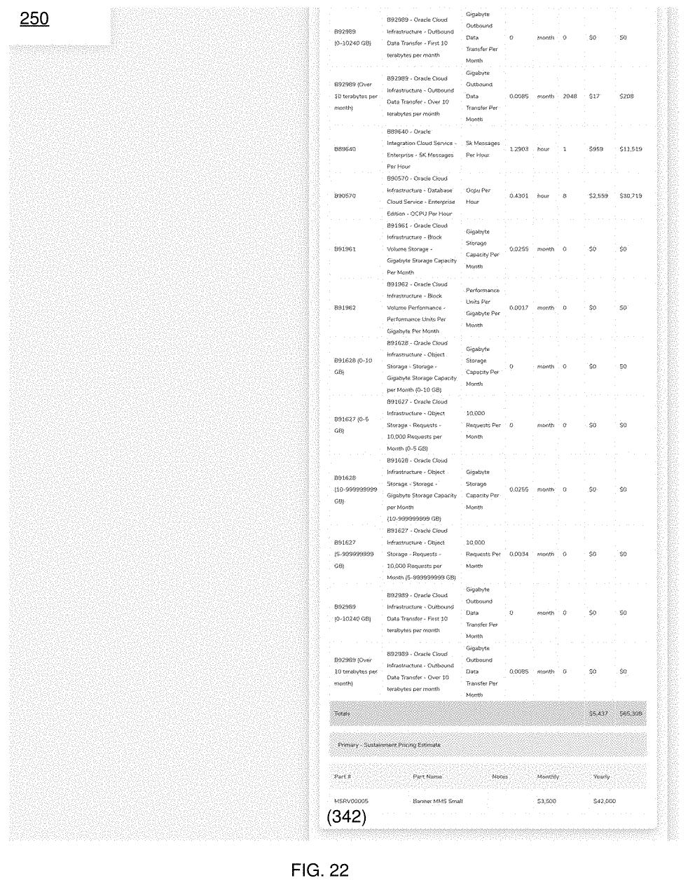

Additionally and referring also to FIG. 20-22, upon selecting (via tapping or a mouse click) the “Estimate” tab, migration evaluation process 10 may render the migration assessment (e.g., migration assessment 100). FIG. 20 illustrates migration assessment 100 in its entirety, while FIG. 21 illustrates upper portion 340 of migration assessment 100 and FIG. 22 illustrates lower portion 342 of migration assessment 100. As discussed above, migration assessment 100 may include one or more of platform migration assessment 124; data migration assessment 126; and post-migration maintenance assessment 128, wherein:
platform migration assessment 124 may provide an estimated cost/timeline for migrating a platform (e.g., software, databases and/or infrastructure) of the client (e.g., user 42) from source workload 116 to target workload 118;
data migration assessment 126 may provide an estimated cost/timeline for migrating data (e.g., software data and/or database data) of the client (e.g., user 42) from source workload 116 to target workload 118; and
post-migration maintenance assessment 128 may provide an estimated cost for maintaining the platform (e.g., software, databases and/or infrastructure) and/or the data (e.g., software data and/or database data) for the client (e.g., user 42) on target workload 118.

Accordingly, the migration assessment (e.g., migration assessment 100) may define a total cost (e.g., a one-time payment and/or monthly payments) for each of platform migration assessment 124, data migration assessment 126, and post-migration maintenance assessment 128 included within migration assessment 100; and/or a total cost (e.g., a one-time payment and/or monthly payments) for migration assessment 100.

Migration Evaluation Comparison

As discussed above, migration evaluation process 10 may define 200 the plurality of migration scenarios (e.g., plurality of migration scenarios 130) within the migration platform (e.g., a migration platform offered by Mythics of Virginia Beach, Va.) and may present 202 the plurality of migration scenarios (e.g., plurality of migration scenarios 130) to the user (e.g., user 36) for review, wherein migration evaluation process 10 may: render 204 user interface 250 that is configured to allow the user (e.g., user 36) to review the plurality of migration scenarios (e.g., plurality of migration scenarios 130); and enable 208 the user (e.g., user 36) to select a specific migration scenario (e.g., specific migration scenario 134) from the plurality of migration scenarios (e.g., plurality of migration scenarios 130) for a potential migration event (e.g., potential migration event 102) from a source workload (e.g., source workload 104) to a target workload (e.g., target workload 106)

Often times, a user (e.g., user 36) may not be committed to a particular service provider and may be interested in comparing the migration costs associated with multiple service providers. Accordingly, migration evaluation process 10 may enable the user (e.g., user 36) to select multiple migration scenarios. For example, assume that the client (e.g., user 42) currently uses Ellucian Banner on-Premise™ (e.g., source workload 116) and wishes to migrate to one of Ellucian Banner in Oracle Cloud™, Azure Cloud™ and Amazon Web Services™ (e.g., target workload 118) . . . but is not committed to any particular platform/service provider (Oracle™, Microsoft™ and Amazon™) Accordingly and in such a situation, migration evaluation process 10 may be configured to essentially allow the user (e.g., user 36) to simultaneously select (in this example) three different migration scenarios:
a first migration scenarios (e.g., Ellucian Banner on-Premise™ [symbol] Ellucian Banner in Oracle Cloud™);
a second migration scenarios (e.g., Ellucian Banner on-Premise™ [symbol] Azure Cloud™); and
a third migration scenarios (e.g., Ellucian Banner on-Premise™ [symbol] AWS Cloud™)

Basically, migration evaluation process 10 may treat this as a single migration scenario that defines a plurality of target workloads (e.g., Ellucian Banner in Oracle Cloud™, Azure Cloud™ and Amazon Web Services™). Once defined, migration evaluation process 10 may gather 212 all of the migration information (e.g., migration information 122) required to generate a migration assessment 100 for each of these migration scenarios. For example, if the first migration scenario needs migration information A+B+C, and the second migration scenario needs migration information A+D+E, and the third migration scenario needs migration information A+E+F, when gathering 212 the migration information (e.g., migration information 122), migration evaluation process 10 may gather 212 migration information A+B+C+D+E+F (as this is the combined information required to generate a migration assessment (e.g., migration assessment 100) for each of these migration scenarios, thus enabling the user (e.g., user 36) to easily compare the migration costs associated with each of these three service providers (e.g., Oracle™, Microsoft™ and Amazon™).

As discussed above, migration information 122 may be provided 214 to and/or utilized 216 by the rules engine (e.g., rules engine 120) to generate migration assessment 100. This migration assessment (e.g., migration assessment 100) may include a plurality of discrete assessments (e.g., discrete assessments 136, 138, 140) that correspond to the plurality of target workloads (e.g., Ellucian Banner in Oracle Cloud™, Azure Cloud™and Amazon Web Services™).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is: CONCEPT 1: A system that allows a user to define their needs/requirements concerning a migration event from a course workload to a target workload (without requiring the user to define technical details concerning e.g., target hardware/target infrastructure) and provides an assessment to the user for a tailored solution that achieves such needs/requirements.

1. A computer-implemented method, executed on a computing device, comprising:
identifying a specific migration scenario for a potential migration event from a source workload to a target workload;
gathering migration information from a user concerning the potential migration event, wherein the migration information defines, in whole or in part, one or more performance requirements concerning the potential migration event; and
processing the specific migration scenario and the migration information to generate a migration assessment concerning the potential migration event.

2. The computer-implemented method of claim 1 wherein one or more of the source workload and the target workload is an on-premise workload.

3. The computer-implemented method of claim 1 wherein one or more of the source workload and the target workload is an in-cloud workload.

4. The computer-implemented method of claim 1 wherein the potential migration event concerns one or more of:
an application migration event;
a database migration event; and
an infrastructure migration event.

5. The computer-implemented method of claim 1 wherein the migration information includes one or more of:
source workload information;
target workload information;
application information;
database information;
infrastructure information;
redundancy information;
high-availability information;
performance information;
data migration information;
migration event timeline information;
environment information; and
post-migration maintenance information.

6. The computer-implemented method of claim 1 further comprising:
providing the migration assessment concerning the potential migration event to the user.

7. The computer-implemented method of claim 1 wherein the migration assessment includes one or more of:
a platform migration assessment;
a data migration assessment; and
a post-migration maintenance assessment.

8. The computer-implemented method of claim 1 wherein the specific migration scenario and/or the migration assessment is based, at least in part, upon knowledge/best practices defined within a rules engine.

9. The computer-implemented method of claim 1 wherein the specific migration scenario is one of a plurality of migration scenarios defined within a migration platform.

10. The computer-implemented method of claim 9 further comprising:
presenting the plurality of migration scenarios to the user for review; and
enabling the user to select the specific migration scenario from the plurality of migration scenarios.

11. A computer program product residing on a computer readable medium having a plurality of instructions stored thereon which, when executed by a processor, cause the processor to perform operations comprising:
identifying a specific migration scenario for a potential migration event from a source workload to a target workload;
gathering migration information from a user concerning the potential migration event, wherein the migration information defines, in whole or in part, one or more performance requirements concerning the potential migration event; and
processing the specific migration scenario and the migration information to generate a migration assessment concerning the potential migration event.

12. The computer program product of claim 11 wherein one or more of the source workload and the target workload is an on-premise workload.

13. The computer program product of claim 11 wherein one or more of the source workload and the target workload is an in-cloud workload.

14. The computer program product of claim 11 wherein the potential migration event concerns one or more of:
an application migration event;
a database migration event; and
an infrastructure migration event.

15. The computer program product of claim 11 wherein the migration information includes one or more of:
source workload information;
target workload information;
application information;
database information;
infrastructure information;
redundancy information;
high-availability information;
performance information;
data migration information;
migration event timeline information;
environment information; and
post-migration maintenance information.

16. The computer program product of claim 11 further comprising:
providing the migration assessment concerning the potential migration event to the user.

17. The computer program product of claim 11 wherein the migration assessment includes one or more of:
a platform migration assessment;
a data migration assessment; and
a post-migration maintenance assessment.

18. The computer program product of claim 11 wherein the specific migration scenario and/or the migration assessment is based, at least in part, upon knowledge/best practices defined within a rules engine.

19. The computer program product of claim 11 wherein the specific migration scenario is one of a plurality of migration scenarios defined within a migration platform.

20. The computer program product of claim 19 further comprising:
presenting the plurality of migration scenarios to the user for review; and
enabling the user to select the specific migration scenario from the plurality of migration scenarios.

21. A computing system including a processor and memory configured to perform operations comprising:
identifying a specific migration scenario for a potential migration event from a source workload to a target workload;
gathering migration information from a user concerning the potential migration event, wherein the migration information defines, in whole or in part, one or more performance requirements concerning the potential migration event; and
processing the specific migration scenario and the migration information to generate a migration assessment concerning the potential migration event.

22. The computing system of claim 21 wherein one or more of the source workload and the target workload is an on-premise workload.

23. The computing system of claim 21 wherein one or more of the source workload and the target workload is an in-cloud workload.

24. The computing system of claim 21 wherein the potential migration event concerns one or more of:
an application migration event;
a database migration event; and
an infrastructure migration event.

25. The computing system of claim 21 wherein the migration information includes one or more of:
source workload information;
target workload information;
application information;
database information;
infrastructure information;
redundancy information;
high-availability information;
performance information;
data migration information;
migration event timeline information;
environment information; and
post-migration maintenance information.

26. The computing system of claim 21 further comprising:
providing the migration assessment concerning the potential migration event to the user.

27. The computing system of claim 21 wherein the migration assessment includes one or more of:
a platform migration assessment;
a data migration assessment; and
a post-migration maintenance assessment.

28. The computing system of claim 21 wherein the specific migration scenario and/or the migration assessment is based, at least in part, upon knowledge/best practices defined within a rules engine.

29. The computing system of claim 21 wherein the specific migration scenario is one of a plurality of migration scenarios defined within a migration platform.

30. The computing system of claim 29 further comprising:
presenting the plurality of migration scenarios to the user for review; and
enabling the user to select the specific migration scenario from the plurality of migration scenarios.
